(19) United States
(12) Patent Application Publication
(10) Pub. No.: US 2025/0031112 A1
(43) Pub. Date: Jan. 23, 2025

(54) AI/ML MODEL SHARING AND SIGNALING FOR ROAMING IN WIRELESS NETWORKS

(71) Applicant: QUALCOMM Incorporated, San Diego, CA (US)

(72) Inventors: Abdel Karim AJAMI, San Diego, CA (US); George CHERIAN, San Diego, CA (US); Sai Yiu Duncan HO, San Diego, CA (US); Gaurang NAIK, San Diego, CA (US); Alfred ASTERJADHI, San Diego, CA (US); Abhishek Pramod PATIL, San Diego, CA (US); Yanjun SUN, San Diego, CA (US)

(21) Appl. No.: 18/356,053

(22) Filed: Jul. 20, 2023

(51) Int. Cl. H04W 36/00; H04W 8/02

(52) U.S. Cl. CPC H04W 36/00837; H04W 8/02

(57) ABSTRACT

This disclosure provides methods, components, devices and systems for multi-link wireless communications. According to certain aspects, a wireless node may obtain information regarding a machine learning (ML) model, obtain inputs for the ML model, provide the inputs to the ML model to generate an inference, and use the inference to make a decision regarding a handover of the wireless node from at least a first access point (AP) device to a second AP device.

### TECHNICAL FIELD

This disclosure relates generally to wireless communication, and more specifically, to techniques for using machine learning models to assist in roaming decisions in wireless networks.

### DESCRIPTION OF THE RELATED TECHNOLOGY

A wireless local area network (WLAN) may be formed by one or more wireless access points (APs) that provide a shared wireless communication medium for use by multiple client devices also referred to as wireless stations (STAs). The basic building block of a WLAN conforming to the Institute of Electrical and Electronics Engineers (IEEE) 802.11 family of standards is a Basic Service Set (BSS), which is managed by an AP. Each BSS is identified by a Basic Service Set Identifier (BSSID) that is advertised by the AP. An AP periodically broadcasts beacon frames to enable any STAs within wireless range of the AP to establish or maintain a communication link with the WLAN.

### SUMMARY

One aspect provides a method for wireless communication at a wireless node. The method includes obtaining information regarding a machine learning (ML) model; obtaining inputs for the ML model; providing the inputs to the ML model to generate an inference; and using the inference to make a decision regarding a handover of the wireless node from at least a first access point (AP) device to a second AP device.

Another aspect provides a method for wireless communication at a first access point (AP) device. The method includes obtaining information regarding at least one of: a machine learning (ML) model designed to generate an inference to aid in making a decision regarding a handover of a wireless node from at least the first AP device to a second AP device, or inputs for the ML model; and outputting the information for transmission to the wireless node.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

FIG. 1 shows a pictorial diagram of an example wireless communication network.

FIG. 2 shows an example protocol data unit (PDU) usable for communications between a wireless access point (AP) and one or more wireless stations (STAs).

FIG. 3 shows a hierarchical format of an example physical layer PDU (PPDU) usable for communications between a wireless AP and one or more wireless STAs.

FIG. 4 shows a pictorial diagram of another example wireless communication network.

FIG. 5 shows an example scenario in which machine learning (ML) assisted roaming proposed herein may be utilized.

FIGS. 6-8 show example ML assisted roaming architectures.

FIG. 9 shows an example call flow diagram for ML assisted roaming proposed herein.

FIG. 10 shows an example flowchart for ML assisted roaming proposed herein.

FIGS. 11A and 11B show examples of ML model inputs and inferences for ML assisted roaming proposed herein.

FIG. 12 shows an example call flow diagram for ML assisted roaming proposed herein.

FIG. 13 shows an example call flow diagram for ML assisted roaming proposed herein.

FIG. 14 shows a flowchart illustrating an example process performable by a wireless node.

FIG. 15 shows a flowchart illustrating an example process performable by an access point (AP).

FIG. 16 shows a block diagram of an example wireless communication device.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

As used herein, “wireless node” generally refers to any type of device capable of communicating wirelessly, such as an access point (AP), a wireless station (STA) serving as an AP (an AP-STA), a STA that is not serving as an AP (a non-AP STA), or a user equipment (UE).

Aspects of the present disclosure provide apparatuses, methods, processing systems, and computer-readable mediums for machine learning (ML) assisted roaming in wireless networks.

Roaming generally refers to the process of a wireless node moving from one (physically distinct) serving access point (AP) device, referred to as a source AP, to another serving AP device, referred to as a target AP. Other terms may also be used to refer to the same or a similar process, such as handover. A wireless node roaming (being handed over) from a source AP to a target AP could be any type of device that supports handover or roaming, such as a non-AP multi-link device (MLD) or a non-AP station (STA) such as a client device. The source AP and/or target AP could be any type of AP device, such as a standalone AP or an AP MLD.

In typical roaming algorithms, a STA scans the available APs and select the AP that has the best Received Signal Strength Indicator (RSSI). In addition, while roaming between networks, several thresholds may be used to trigger a roaming decision. For example, these thresholds may include a first RSSI threshold T1, under which the STA can start the link selection process, and another threshold T2 which corresponds to the RSSI difference between the new link and the old link. In other cases, the STA may also consider BSS loading.

In many cases, a STA may use fixed thresholds which are not adapted to the environment and, hence, may lead to a bad user experience when roaming between different networks. Further, a client may not have all the inputs/resources (e.g., due to processing or power limitations) to perform the necessary processing for the best roaming experience.

In some cases, artificial intelligence (AI) and/or machine learning (ML) models (or simply ML models) may be leveraged to aid in roaming decisions. ML assisted roaming may be used, for example, in ultra-high reliability (UHR) wireless system roaming scenarios. In non-collocated multi-link operation (MLO), a STA may associate to a single mobility domain (SMD) MLD that is affiliated with multiple non-collocated APs.

One goal of non-collocated MLO may be to ensure a seamless roaming experience to clients, and roaming can be initiated by the AP or by the non-AP STA. As noted above, a simple mechanism for roaming between APs can rely on the signal strength and hence select the AP that has the strongest signal. Unfortunately, this mechanism may lead to under-utilization of some APs while overloading others.

Aspects of the present disclosure provide mechanisms that may utilize ML models to assist roaming decisions in a manner designed to improve network throughput. For example, such ML models may make roaming decisions considering factors designed to balance the loads at the affiliated APs. Techniques proposed herein provide ML-assisted roaming solutions that can be network centric (centralized), client centric (distributed), or a combination thereof. As will be described in greater detail below, the techniques may enable (AI/ML) model sharing by providing a signaling framework that may be used in many use cases (such as UHR roaming).

As a result, the techniques proposed herein help make handover decisions that may result in improved network throughput, avoid delays, and improve overall user experience. In some cases, utilizing ML based roaming, more clients may be able to achieve target key performance indicators (KPIs), which may help entities satisfy service level agreements.

### Example Wireless Communication Network

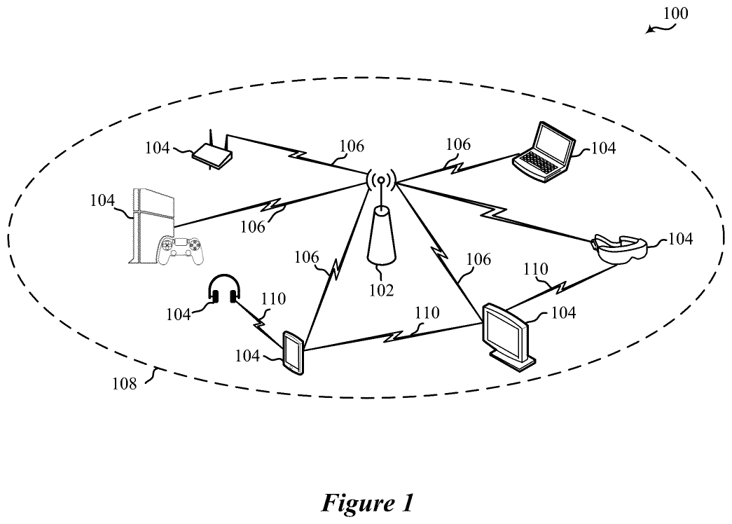

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bd, 802.11be, 802.11bf, and 802.11bn). In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core.

The wireless communication network 100 may include numerous wireless communication devices including at least one wireless access point (AP) 102 and any number of wireless stations (STAs) 104. While only one AP 102 is shown in FIG. 1, the wireless communication network 100 can include multiple APs 102. The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (CNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as a basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some cases, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some cases, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the WLAN 100 may transmit PPDUs over an unlicensed spectrum, which may be a portion of spectrum that includes frequency bands traditionally used by Wi-Fi technology, such as the 2.4 GHZ, 5 GHZ, 6 GHZ, 45 GHZ, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHZ), FR3 (7.125 GHZ-24.25 GHZ), FR4a or FR4-1 (52.6 GHZ-71 GHZ), FR4 (52.6 GHZ-114.25 GHZ), and FR5 (114.25 GHz-300 GHZ).

Each of the frequency bands may include multiple sub-bands and frequency channels (also referred to as subchannels). For example, PPDUs conforming to the IEEE 802.11n, 802.11ac, 802.11ax, 802.11be and 802.11bn standard amendments may be transmitted over one or more of the 2.4 GHZ, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHZ, 80 MHZ, 160 MHZ, 240 MHZ, 320 MHZ, 480 MHz, or 640 MHz by bonding together multiple 20 MHz channels.

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 protocol to be used to transmit the payload

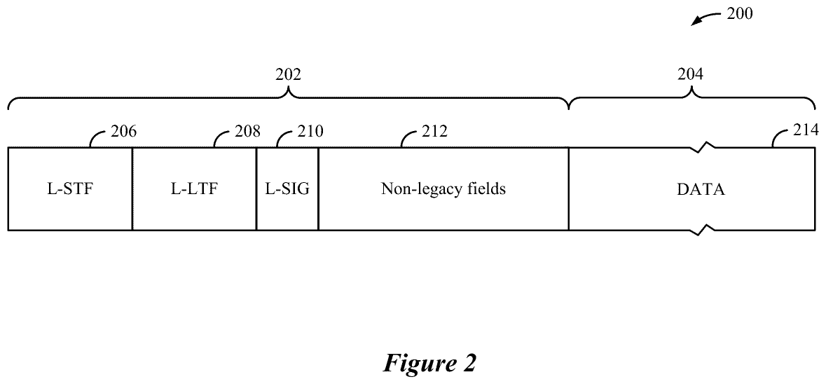

FIG. 2 shows an example protocol data unit (PDU) 200 usable for wireless communication between a wireless AP 102 and one or more wireless STAs 104. For example, the PDU 200 can be configured as a PPDU. As shown, the PDU 200 includes a PHY preamble 202 and a PHY payload 204. For example, the preamble 202 may include a legacy portion that itself includes a legacy short training field (L-STF) 206, which may consist of two symbols, a legacy long training field (L-LTF) 208, which may consist of two symbols, and a legacy signal field (L-SIG) 210, which may consist of two symbols. The legacy portion of the preamble 202 may be configured according to the IEEE 802.11a wireless communication protocol standard. The preamble 202 also may include a non-legacy portion including one or more non-legacy fields 212, for example, conforming to one or more of the IEEE 802.11 family of wireless communication protocol standards.

The L-STF 206 generally enables a receiving device to perform coarse timing and frequency tracking and automatic gain control (AGC). The L-LTF 208 generally enables a receiving device to perform fine timing and frequency tracking and also to perform an initial estimate of the wireless channel. The L-SIG 210 generally enables a receiving device to determine (for example, obtain, select, identify, detect, ascertain, calculate, or compute) a duration of the PDU and to use the determined duration to avoid transmitting on top of the PDU. The legacy portion of the preamble, including the L-STF 206, the L-LTF 208 and the L-SIG 210, may be modulated according to a binary phase shift keying (BPSK) modulation scheme. The payload 204 may be modulated according to a BPSK modulation scheme, a quadrature BPSK (Q-BPSK) modulation scheme, a quadrature amplitude modulation (QAM) modulation scheme, or another appropriate modulation scheme. The payload 204 may include a PSDU including a data field (DATA) 214 that, in turn, may carry higher layer data, for example, in the form of MAC protocol data units (MPDUs) or an aggregated MPDU (A-MPDU).

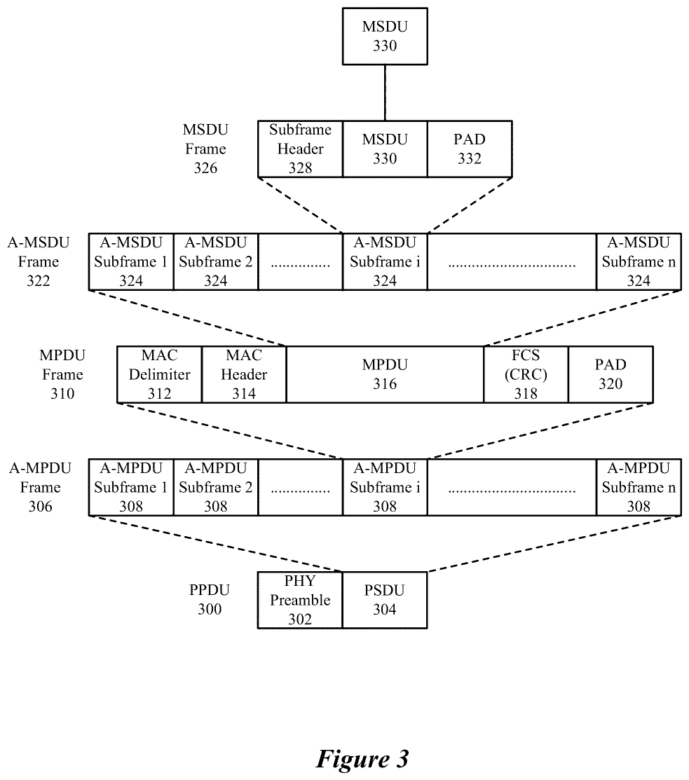

FIG. 3 shows a hierarchical format of an example PPDU usable for communications between a wireless AP 102 and one or more wireless STAs 104. As described, each PPDU 300 includes a PHY preamble 302 and a PSDU 304. Each PSDU 304 may represent (or “carry”) one or more MAC protocol data units (MPDUs) 316. For example, each PSDU 304 may carry an aggregated MPDU (A-MPDU) 306 that includes an aggregation of multiple A-MPDU subframes 308. Each A-MPDU subframe 306 may include an MPDU frame 310 that includes a MAC delimiter 312 and a MAC header 314 prior to the accompanying MPDU 316, which includes the data portion (“payload” or “frame body”) of the MPDU frame 310. Each MPDU frame 310 also may include a frame check sequence (FCS) field 318 for error detection (for example, the FCS field may include a cyclic redundancy check (CRC)) and padding bits 320. The MPDU 316 may carry one or more MAC service data units (MSDUs). For example, the MPDU 316 may carry an aggregated MSDU (A-MSDU) 322 including multiple A-MSDU subframes 324. Each A-MSDU subframe 324 contains a corresponding MSDU 330 preceded by a subframe header 328 and in some cases followed by padding bits 332.

Referring back to the MPDU frame 310, the MAC delimiter 312 may serve as a marker of the start of the associated MPDU 316 and indicate the length of the associated MPDU 316. The MAC header 314 may include multiple fields containing information that defines or indicates characteristics or attributes of data encapsulated within the frame body 316. The MAC header 314 includes a duration field indicating a duration extending from the end of the PPDU until at least the end of an acknowledgment (ACK) or Block ACK (BA) of the PPDU that is to be transmitted by the receiving wireless communication device. The use of the duration field serves to reserve the wireless medium for the indicated duration, and enables the receiving device to establish its network allocation vector (NAV). The MAC header 314 also includes one or more fields indicating addresses for the data encapsulated within the frame body 316. For example, the MAC header 314 may include a combination of a source address, a transmitter address, a receiver address or a destination address. The MAC header 314 may further include a frame control field containing control information. The frame control field may specify a frame type, for example, a data frame, a control frame, or a management frame.

Some APs and STAs may implement techniques for spatial reuse that involve participation in a coordinated communication scheme. According to such techniques, an AP may contend for access to a wireless medium to obtain control of the medium for a TXOP. The AP that wins the contention (hereinafter also referred to as a “sharing AP”) may select one or more other APs (hereinafter also referred to as “shared APs”) to share resources of the TXOP. The sharing and shared APs may be located in proximity to one another such that at least some of their wireless coverage areas at least partially overlap. Some examples may specifically involve coordinated AP TDMA or OFDMA techniques for sharing the time or frequency resources of a TXOP. To share its time or frequency resources, the sharing AP may partition the TXOP into multiple time segments or frequency segments each including respective time or frequency resources representing a portion of the TXOP, The sharing AP may allocate the time or frequency segments to itself or to one or more of the shared APs. For example, each shared AP may utilize a partial TXOP assigned by the sharing AP for its uplink or downlink communications with its associated STAs.

In some examples of such TDMA techniques, each portion of a plurality of portions of the TXOP includes a set of time resources that do not overlap with any time resources of any other portion of the plurality of portions. In such examples, the scheduling information may include an indication of time resources, of multiple time resources of the TXOP, associated with each portion of the TXOP. For example, the scheduling information may include an indication of a time segment of the TXOP such as an indication of one or more slots or sets of symbol periods associated with each portion of the TXOP such as for multi-user TDMA.

In some other examples of OFDMA techniques, each portion of the plurality of portions of the TXOP includes a set of frequency resources that do not overlap with any frequency resources of any other portion of the plurality of portions. In such implementations, the scheduling information may include an indication of frequency resources, of multiple frequency resources of the TXOP, associated with each portion of the TXOP. For example, the scheduling information may include an indication of a bandwidth portion of the wireless channel such as an indication of one or more subchannels or resource units (RUs) associated with each portion of the TXOP such as for multi-user OFDMA.

In this manner, the sharing AP's acquisition of the TXOP enables communication between one or more additional shared APs and their respective BSSs, subject to appropriate power control and link adaptation. For example, the sharing AP may limit the transmit powers of the selected shared APs such that interference from the selected APs does not prevent STAs associated with the TXOP owner from successfully decoding packets transmitted by the sharing AP. Such techniques may be used to reduce latency because the other APs may not need to wait to win contention for a TXOP to be able to transmit and receive data according to conventional CSMA/CA or EDCA techniques. Additionally, by enabling a group of APs associated with different BSSs to participate in a coordinated AP transmission session, during which the group of APs may share at least a portion of a single TXOP obtained by any one of the participating APs, such techniques may increase throughput across the BSSs associated with the participating APs and may also achieve improvements in throughput fairness. Furthermore, with appropriate selection of the shared APs and the scheduling of their respective time or frequency resources, medium utilization may be maximized or otherwise increased while packet loss resulting from OBSS interference is minimized or otherwise reduced. Various implementations may achieve these and other advantages without requiring that the sharing AP or the shared APs be aware of the STAs associated with other BSSs, without requiring a preassigned or dedicated master AP or preassigned groups of APs, and without requiring backhaul coordination between the APs participating in the TXOP.

In some examples in which the signal strengths or levels of interference associated with the selected APs are relatively low (such as less than a given value), or when the decoding error rates of the selected APs are relatively low (such as less than a threshold), the start times of the communications among the different BSSs may be synchronous. Conversely, when the signal strengths or levels of interference associated with the selected APs are relatively high (such as greater than the given value), or when the decoding error rates of the selected APs are relatively high (such as greater than the threshold), the start times may be offset from one another by a time period associated with decoding the preamble of a wireless packet and determining, from the decoded preamble, whether the wireless packet is an intra-BSS packet or is an OBSS packet. For example, the time period between the transmission of an intra-BSS packet and the transmission of an OBSS packet may allow a respective AP (or its associated STAs) to decode the preamble of the wireless packet and obtain the BSS color value carried in the wireless packet to determine whether the wireless packet is an intra-BSS packet or an OBSS packet. In this manner, each of the participating APs and their associated STAs may be able to receive and decode intra-BSS packets in the presence of OBSS interference.

In some examples, the sharing AP may perform polling of a set of un-managed or non-co-managed APs that support coordinated reuse to identify candidates for future spatial reuse opportunities. For example, the sharing AP may transmit one or more spatial reuse poll frames as part of determining one or more spatial reuse criteria and selecting one or more other APs to be shared APs. According to the polling, the sharing AP may receive responses from one or more of the polled APs. In some specific examples, the sharing AP may transmit a coordinated AP TXOP indication (CTI) frame to other APs that indicates time and frequency of resources of the TXOP that can be shared. The sharing AP may select one or more candidate APs upon receiving a coordinated AP TXOP request (CTR) frame from a respective candidate AP that indicates a desire by the respective AP to participate in the TXOP. The poll responses or CTR frames may include a power indication, for example, an RX power or RSSI measured by the respective AP. In some other examples, the sharing AP may directly measure potential interference of a service supported (such as UL transmission) at one or more APs, and select the shared APs based on the measured potential interference. The sharing AP generally selects the APs to participate in coordinated spatial reuse such that it still protects its own transmissions (which may be referred to as primary transmissions) to and from the STAs in its BSS. The selected APs may then be allocated resources during the TXOP as described above.

Retransmission protocols, such as hybrid automatic repeat request (HARQ), also may offer performance gains. A HARQ protocol may support various HARQ signaling between transmitting and receiving wireless communication devices as well as signaling between the PHY and MAC layers to improve the retransmission operations in a WLAN. HARQ uses a combination of error detection and error correction. For example, a HARQ transmission may include error checking bits that are added to data to be transmitted using an error-detecting (ED) code, such as a cyclic redundancy check (CRC). The error checking bits may be used by the receiving device to determine if it has properly decoded the received HARQ transmission. In some examples, the original data (information bits) to be transmitted may be encoded with a forward error correction (FEC) code, such as using a low-density parity check (LDPC) coding scheme that systematically encodes the information bits to produce parity bits. The transmitting device may transmit both the original information bits as well as the parity bits in the HARQ transmission to the receiving device. The receiving device may be able to use the parity bits to correct errors in the information bits, thus avoiding a retransmission.

Implementing a HARQ protocol in a WLAN may improve reliability of data communicated from a transmitting device to a receiving device. The HARQ protocol may support the establishment of a HARQ session between the two devices. Once a HARQ session is established, If a receiving device cannot properly decode (and cannot correct the errors) a first HARQ transmission received from the transmitting device, the receiving device may transmit a HARQ feedback message to the transmitting device (for example, a negative acknowledgement (NACK)) that indicates at least part of the first HARQ transmission was not properly decoded. Such a HARQ feedback message may be different than the traditional Block ACK feedback message type associated with conventional ARQ. In response to receiving the HARQ feedback message, the transmitting device may transmit a second HARQ transmission to the receiving device to communicate at least part of further assist the receiving device in decoding the first HARQ transmission. For example, the transmitting device may include some or all of the original information bits, some or all of the original parity bits, as well as other, different parity bits in the second HARQ transmission. The combined HARQ transmissions may be processed for decoding and error correction such that the complete signal associated with the HARQ transmissions can be obtained.

In some examples, the receiving device may be enabled to control whether to continue the HARQ process or revert to a non-HARQ retransmission scheme (such as an ARQ protocol). Such switching may reduce feedback overhead and increase the flexibility for retransmissions by allowing devices to dynamically switch between ARQ and HARQ protocols during frame exchanges. Some implementations also may allow multiplexing of communications that employ ARQ with those that employ HARQ.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

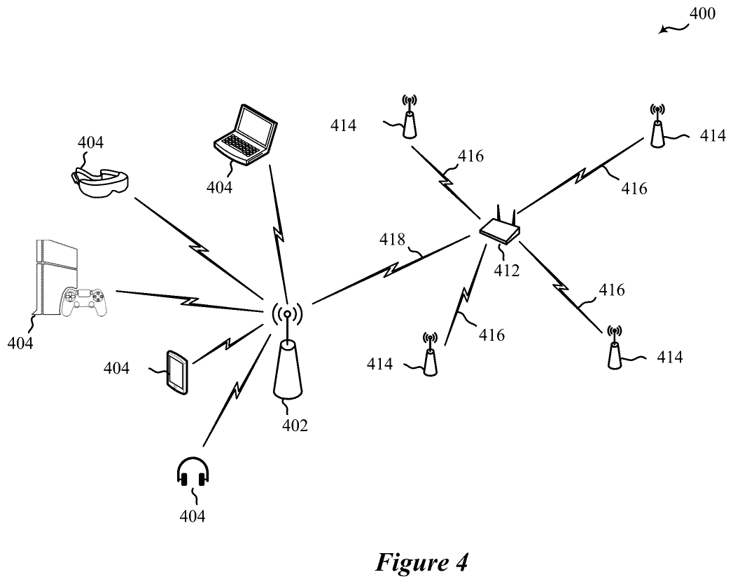

FIG. 4 shows a pictorial diagram of another example wireless communication network 400. According to some aspects, the wireless communication network 400 can be an example of a mesh network, an IoT network or a sensor network in accordance with one or more of the IEEE 802.11 family of wireless communication protocol standards (including the 802.11ah amendment). The wireless network 400 may include multiple wireless communication devices 414. The wireless communication devices 414 may represent various devices such as display devices (for example, TVs, computer monitors, navigation systems, among others), music or other audio or stereo devices, remote control devices (“remotes”), printers, kitchen or other household appliances, among other examples.

In some examples, the wireless communication devices 414 sense, measure, collect or otherwise obtain and process data and then transmit such raw or processed data to an intermediate device 412 for subsequent processing or distribution. Additionally or alternatively, the intermediate device 412 may transmit control information, digital content (for example, audio or video data), configuration information or other instructions to the wireless communication devices 414. The intermediate device 412 and the wireless communication devices 414 can communicate with one another via wireless communication links 416. In some examples, the wireless communication links 416 include Bluetooth links or other PAN or short-range communication links.

In some examples, the intermediate device 412 also may be configured for wireless communication with other networks such as with a Wi-Fi WLAN 100 or a wireless (for example, cellular) wide area network (WWAN), which may, in turn, provide access to external networks including the Internet. For example, the intermediate device 412 may associate and communicate, over a Wi-Fi link 418, with an AP 402 of a WLAN network, which also may serve various STAs 404. In some examples, the intermediate device 412 is an example of a network gateway, for example, an IoT gateway. In such a manner, the intermediate device 412 may serve as an edge network bridge providing a Wi-Fi core backhaul for the IoT network including the wireless communication devices 414. In some examples, the intermediate device 412 can analyze, preprocess and aggregate data received from the wireless communication devices 414 locally at the edge before transmitting it to other devices or external networks via the Wi-Fi link 418. The intermediate device 412 also can provide additional security for the IoT network and the data it transports.

Some wireless communication devices (including both APs and STAs) are capable of multi-link operation (MLO). In some examples, MLO supports establishing multiple different communication links (such as a first link on the 2.4 GHz band, a second link on the 5 GHz band, and the third link on the 6 GHz band) between the STA and the AP. Each communication link may support one or more sets of channels or logical entities. In some cases, each communication link associated with a given wireless communication device may be associated with a respective radio of the wireless communication device, which may include one or more transmit/receive (Tx/Rx) chains, include or be coupled with one or more physical antennas, or include signal processing components, among other components. An MLO-capable device may be referred to as a multi-link device (MLD). For example, an AP MLD may include multiple APs each configured to communicate on a respective communication link with a respective one of multiple STAs of a non-AP MLD (also referred to as a “STA MLD”). The STA MLD may communicate with the AP MLD over one or more of the multiple communication links at a given time.

One type of MLO is multi-link aggregation (MLA), where traffic associated with a single STA is simultaneously transmitted across multiple communication links in parallel to maximize the utilization of available resources to achieve higher throughput. That is, during at least some duration of time, transmissions or portions of transmissions may occur over two or more links in parallel at the same time. In some examples, the parallel wireless communication links may support synchronized transmissions. In some other examples, or during some other durations of time, transmissions over the links may be parallel, but not be synchronized or concurrent. In some examples or durations of time, two or more of the links may be used for communications between the wireless communication devices in the same direction (such as all uplink or all downlink). In some other examples or durations of time, two or more of the links may be used for communications in different directions. For example, one or more links may support uplink communications and one or more links may support downlink communications. In such examples, at least one of the wireless communication devices operates in a full duplex mode. Generally, full duplex operation enables bi-directional communications where at least one of the wireless communication devices may transmit and receive at the same time.

MLA may be implemented in a number of ways. In some examples, MLA may be packet-based. For packet-based aggregation, frames of a single traffic flow (such as all traffic associated with a given traffic identifier (TID)) may be sent concurrently across multiple communication links. In some other examples, MLA may be flow-based. For flow-based aggregation, each traffic flow (such as all traffic associated with a given TID) may be sent using a single one of multiple available communication links. As an example, a single STA MLD may access a web browser while streaming a video in parallel. The traffic associated with the web browser access may be communicated over a first communication link while the traffic associated with the video stream may be communicated over a second communication link in parallel (such that at least some of the data may be transmitted on the first channel concurrently with data transmitted on the second channel).

In some other examples, MLA may be implemented as a hybrid of flow-based and packet-based aggregation. For example, an MLD may employ flow-based aggregation in situations in which multiple traffic flows are created and may employ packet-based aggregation in other situations. The determination to switch among the MLA techniques or modes may additionally or alternatively be associated with other metrics (such as a time of day, traffic load within the network, or battery power for a wireless communication device, among other factors or considerations).

To support MLO techniques, an AP MLD and a STA MLD may exchange supported MLO capability information (such as supported aggregation type or supported frequency bands, among other information). In some examples, the exchange of information may occur via a beacon signal, a probe request or probe response, an association request or an association response frame, a dedicated action frame, or an operating mode indicator (OMI), among other examples. In some examples, an AP MLD may designate a given channel in a given band as an anchor channel (such as the channel on which it transmits beacons and other management frames). In such examples, the AP MLD also may transmit beacons (such as ones which may contain less information) on other channels for discovery purposes.

MLO techniques may provide multiple benefits to a WLAN. For example, MLO may improve user perceived throughput (UPT) (such as by quickly flushing per-user transmit queues). Similarly, MLO may improve throughput by improving utilization of available channels and may increase spectral utilization (such as increasing the bandwidth-time product). Further, MLO may enable smooth transitions between multi-band radios (such as where each radio may be associated with a given RF band) or enable a framework to set up separation of control channels and data channels. Other benefits of MLO include reducing the ON time of a modem, which may benefit a wireless communication device in terms of power consumption. Another benefit of MLO is the increased multiplexing opportunities in the case of a single BSS. For example, multi-link aggregation may increase the number of users per multiplexed transmission served by the multi-link AP MLD.

The techniques proposed herein may be applied in various scenarios, including station-initiated (or client-initiated) handover scenarios and network-initiated handover scenarios. The techniques proposed herein may also be applied to handover scenarios involving devices of different capabilities, such as single radio stations and multi-radio stations.

As used herein, handover generally refers to the process of a wireless node moving from one serving AP device, referred to as a source AP, to another serving AP device, referred to as a target AP. In some cases, the serving AP device and source AP device may be physically distinct (e.g., and may be in different locations). Other terms may also be used to refer to the same or a similar process, such as roaming or seamless roaming.

A wireless node being handed over (or roaming) from a source AP to a target AP could be any type of device that supports handover or seamless roaming, such as a non-AP MLD or a non-AP STA (e.g., a client device). The source AP and/or target AP could be any type of AP device, such as a standalone AP or an AP MLD.

In the handover scenarios described herein, the source AP and target AP may both be affiliated with a single mobility domain (SMD) entity, such as an SMD AP MLD. In this context, an SMD entity generally refers to a logical entity that comprises more than one non-collocated AP device such that a non-AP device that is associated with the SMD entity can seamlessly roam (e.g., without requiring re-association) between the AP devices affiliated with the SMD entity. In this context, an AP device (affiliated with an SMD entity) can be an AP MLD which comprises one or more affiliated APs or a single link AP. A non-AP device can be a non-AP MLD which comprises one or more affiliated non-AP STAs or a single link non-AP STA.

The source AP and target AP may be affiliated with different (normal or non-SMD) AP MLDs. An SMD AP MLD may be similar to a normal AP MLD, in that it may control multiple APs affiliated therewith. One difference, however, is that APs affiliated with the SMD AP MLD may be in different locations (non-collocated), while APs affiliated to a same normal AP MLD are typically in the same location (collocated).

One example of an SMD entity is an SMD MLD, which may refer to a logical entity that can reside, for example, on a network controller or a serving AP MLD for a particular client. For the latter case, the physical AP that provides (activates/operates) SMD MLD functionality can be different for different clients and therefore the physical location of SMD MLD can be different for different clients. Further, some operations or functionality can be split between an AP MLD and an SMD MLD. For example, functionality related to association context, block acknowledgment (BA), and/or security may reside on the SMD MLD for a particular client, while other functionality related to a Link ID may be based on the serving AP MLD. This is in contrast to a conventional station (e.g., a legacy client) such as an 802.11be compliant non-AP MLD, where such functionalities may all reside on the physical AP MLD that is serving that non-AP MLD. While the present disclosure refers to an entity that provides the functionality described above as an SMD MLD, entities providing the same or similar functionality may be referred to by other names.

### Example AI/ML Model Sharing and Signaling Framework for Roaming

As noted above, in typical roaming algorithms, a STA scans the available APs and select the AP that has the best Received Signal Strength Indicator (RSSI). In many cases, a STA may use fixed thresholds which are not adapted to the environment and, hence, may lead to a bad user experience when roaming between different networks. Further, a client may not have all the inputs/resources (e.g., due to processing or power limitations) to perform the necessary processing for the best roaming experience.

Aspects of the present disclosure provide mechanisms that may utilize ML models to assist roaming decisions in a manner designed to improve network throughput. For example, such ML models may make roaming decisions considering factors designed to balance the loads at the affiliated APs.

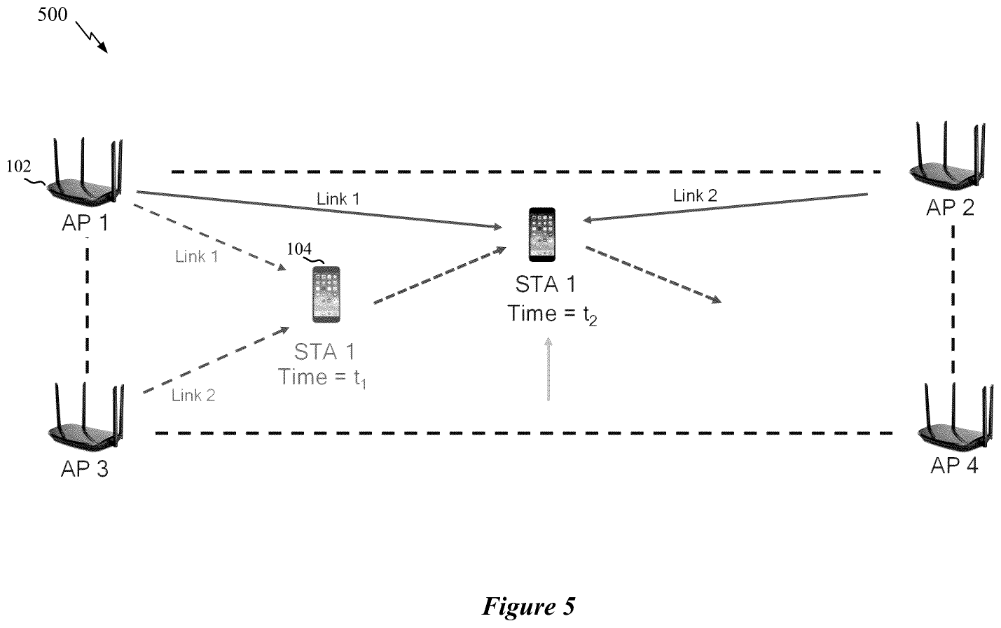

The techniques may be utilized to assist in making roaming decisions for a station, such as STA1 illustrated in the scenario 500 shown in FIG. 5. As illustrated, at a first time (t1), STA1 may be in communication with a first sets of APs, AP1 and AP3 (via Link 1 and Link 2). After the STA 1 moves (in a direction towards AP2 and AP4), at a second time (t2), STA 1 may be handed over from AP 3 to AP2. In the illustrated example, STA 1 may maintain the link (Link 1) with AP1.

Techniques proposed herein provide ML-assisted roaming solutions that can be used in different types of roaming scenarios, including network centric (centralized) and/or client centric (distributed). Network centric roaming may be considered a centralized ML approach in that roaming decisions may be made on the network side. In this case, a client may still request to roam with another AP, but the network may make the ultimate decision. In some cases, the client may also provide inputs that can be used by the model. These inputs may include, for example, Beacon measurements, packet statistics, or output from another ML model (running on the client).

Client centric roaming may be considered a distributed AI/ML approach. In this case, a client may use its own AI/ML model based on obtained inputs. These inputs may be obtained locally (at the client/STA) or obtained from an AP or other type of wireless node. For example, the inputs may include local measurements or observations, measurements from the AP, reports provided by the AP, and/or results of (off-) channel scanning. In some cases, an AP may download a model on to clients and/or provide inputs to AI/ML model.

Utilizing the ML assisted roaming techniques proposed herein, a wireless node (e.g., a client STA) may obtain information regarding an ML model, obtain inputs for the ML model and use the inputs to the ML model to generate an inference used to make a decision regarding a handover of the wireless node from at least a first AP device to a second AP device.

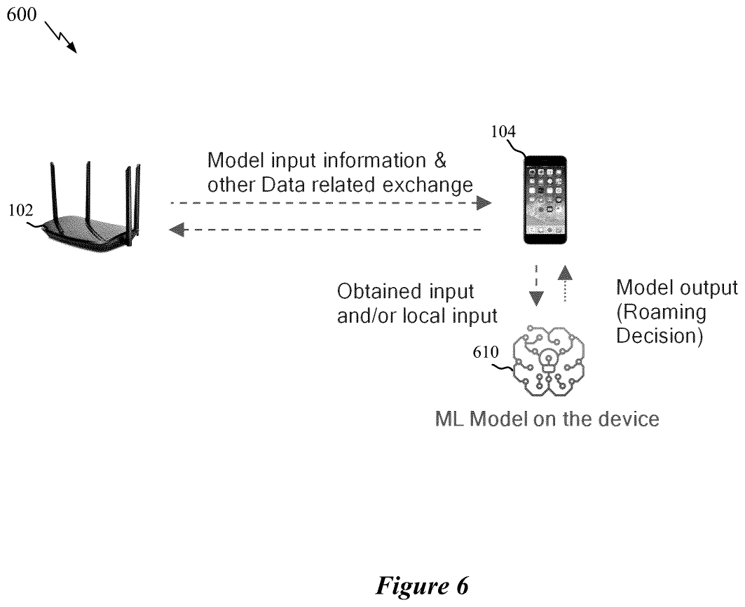

The ML assisted roaming techniques proposed herein may be utilized in various different types of AI/ML roaming architectures, such as those shown in FIGS. 6-8.

In the example architecture 600 shown in FIG. 6, information is exchanged between (AP and non-AP) STAs that use independent roaming models. In the illustrated example, a STA 104 provides input (locally obtained or obtained from another wireless node) as input to an ML model 610 on the device. As illustrated, in some cases, the model output may be a roaming decision.

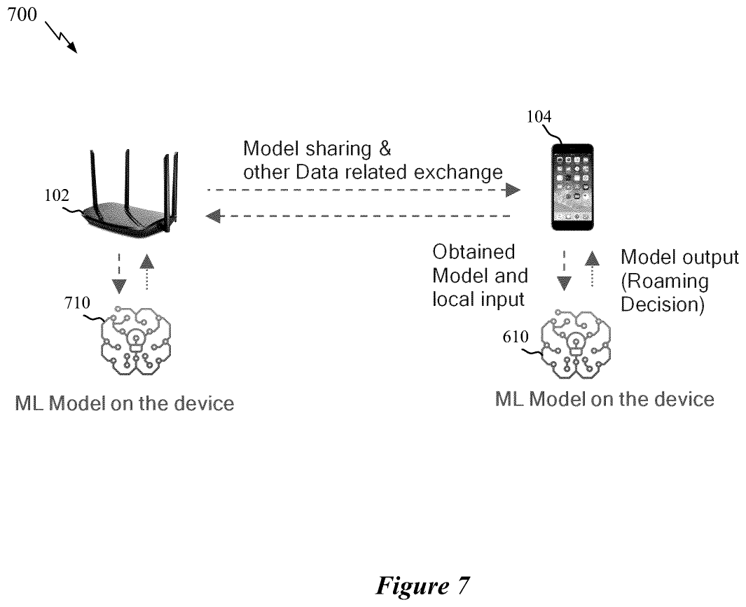

In the example architecture 700 shown in FIG. 7, a model is exchanged between STAs that use a shared/aggregated model (610/710). In this case, the client STA may use the obtained model and local input to generate a roaming decision.

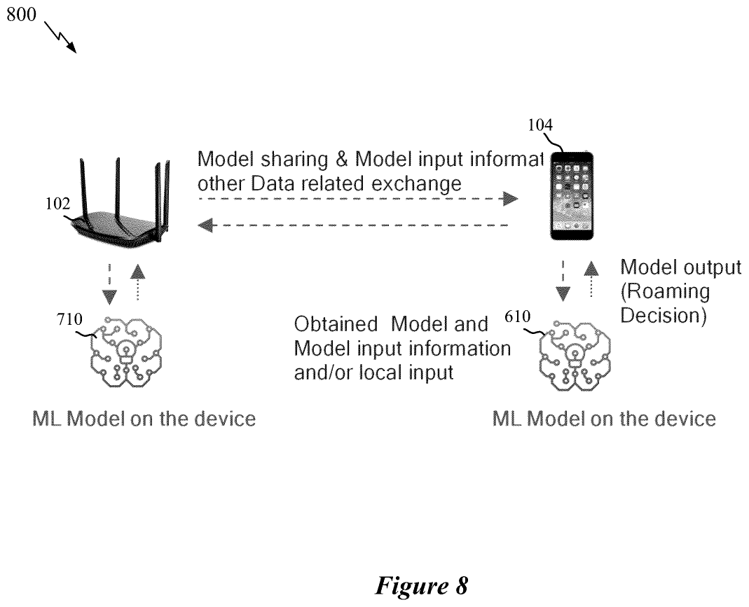

In the example architecture 800 shown in FIG. 8, information is exchanged between (AP and non-AP) STAs that use a shared/aggregated roaming model (610/710). In the illustrated example, a STA 104 provides input (locally obtained or obtained from another wireless node) as input to an ML model 610 on the device. As illustrated, in some cases, the model output may be a roaming decision.

In the example architecture 700 shown in FIG. 7, a model is exchanged between STAs that use shared/an aggregated model (610/710). In this case, the client STA may obtained model input and local input (e.g., measurements/observations). Again, the model output may be a roaming decision.

In the example architecture 800 shown in FIG. 8, model and model information may be exchanged between the AP and non-AP STAs. The STAs may use a shared/aggregated model with shared and/or local input. The (non-AP) STA may use the obtained model, model input information, as well as local input (e.g., measurements/observations) to generate a roaming decision.

In some cases, in the AI/ML model architectures shown in FIG. 7 and FIG. 8, the AP 102 may generate (inference) data via its ML model 710 and exchange that with the STA 104.

As illustrated in FIGS. 6-8, depending on a particular implementation, various components, at the AP and STA, used for ML assisted roaming can be used together or independently. The particular implementation may determine the particular signaling used to exchange information that can be used as input or to configure the ML model (at the STA, AP, or both).

The types of information exchanged may include both model inputs, as well as indication of which specific inputs to use, along with model parameter updates. Signaling can also be used to exchange information regarding the particular ML model or model type to use, for example, via an ML model download, ML model update, upload, or direct (e.g., STA-to-STA) sharing.

STAs, APs, or both can also exchange local observations from other devices or provide feedback related to the communication with the device. This may significantly expand the types of input that can be considered as input to the ML model used for enhanced roaming decisions, as such information may not be available at the other STA/AP. For example, this information may include observed RSSI from different APs, experienced packet success/failure/retry rate per client/AP, BSS/Quality of Service (QOS) load/requirements, and history of bad/good AP link(s), which could be conveyed in terms of scores and/or rankings).

As noted above, sharing of model or model information may be accomplished by any suitable signaling. Such signaling includes downloading, uploading, direct sharing, and signaling of updates. STAs (including AP and non-AP STAs) can share information regarding the ML model with other STAs. This information may include selected parameters, selected components, or all parameters/components. Upon receiving (information for) a model, the STAs can then either use the model/components as is or merge it with another models/components. In other words, in some cases, multiple models may be used to enhance roaming decisions.

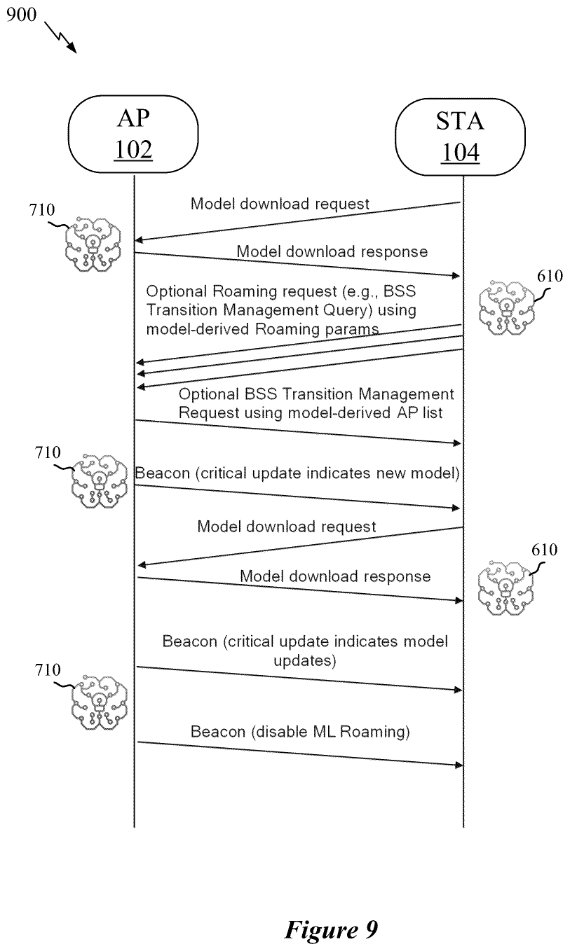

As illustrated in the call flow diagram of FIG. 9, in some cases, a STA may send a model download request and an AP may provide model related information in a model download response. In some cases, the information may be generated (at least in part) by model 710 at the AP.

The STA may use the information (as well as locally obtained input) to generate an inference (e.g., a roaming decision or roaming parameters) using model 610 at the STA. In some cases, based on the inference, the STA may send a roaming request (e.g., via a BSS transition management query), for example, using model-derived roaming parameters. Similarly, the AP may send an optional BSS transition management request, for example, using a model-derived AP list.

As illustrated in FIG. 9, the AP may send (critical) updates, for example, indicating a new model via a beacon. The update may be based on an inference from model 710 and/or performance monitoring. The update may prompt another model download request/response sequence.

As illustrated in FIG. 9, in some cases, the AP may indicate (e.g., via a beacon) that ML assisted roaming should be disabled. This decision may be based on performance monitoring. For example, if performance is not satisfactory, the AP may decide to disable ML roaming.

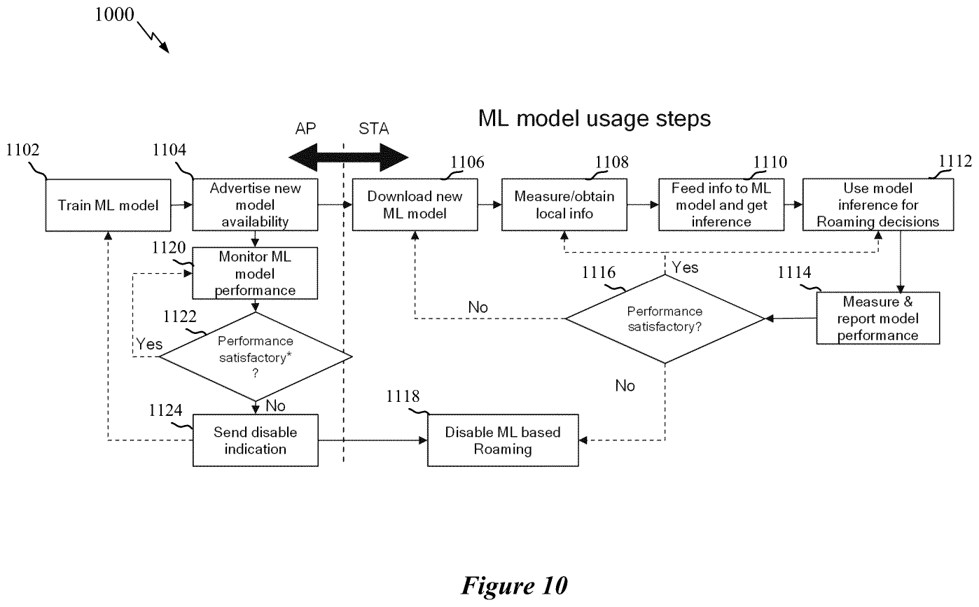

FIG. 10 shows an example flowchart for ML assisted roaming proposed herein, indicating example operations performed at the AP side and STA side.

In the illustrated example, the AP offers downloadable ML model to associated STAs. In some cases, the model input at the STA may include local information only. The STA(s) may use the downloaded model to determine roaming parameters and/or threshold(s) to use when making decisions to roam to another AP.

As illustrated, on the AP side, the AP may train an ML model at 1102. At 1104, the AP may advertise the new model availability.

On the STA side, the STA may download the new ML model, at 1106. At 1108, the STA measures/obtains local information, which is fed to the ML model to generate an inference, at 1110. At 1112, the STA uses the model inference for roaming decisions.

In some cases, model performance may be monitored and used, for example, to update model parameters, switch to a different model, or disable ML based roaming. In some cases, the performance may be based on metrics achieved after a handover decision is made (e.g., based on measured performance after a handover, such as throughput, packet error rate, and/or other metrics). In a home or enterprise scenario a controller entity may monitor a client roaming performance or client may report back.

At 1114, the STA measures and reports model performance (e.g., to the AP). As shown at 1116, if model performance is not satisfactory, the STA may download a new model (at 1106) or may disable ML based roaming at 1118.

As shown at 1120, ML model performance may also be monitored at the AP side (e.g., based on information reported by the STA, other STAs, other APs, or observed by the AP). As shown at 1122, if model performance is not satisfactory, the AP may send a disable indication (e.g., via a beacon), at 1124.

As noted above, an ML model may be used to make roaming decisions and/or may be used to generate roaming parameters (e.g., to dynamically adapt roaming thresholds).

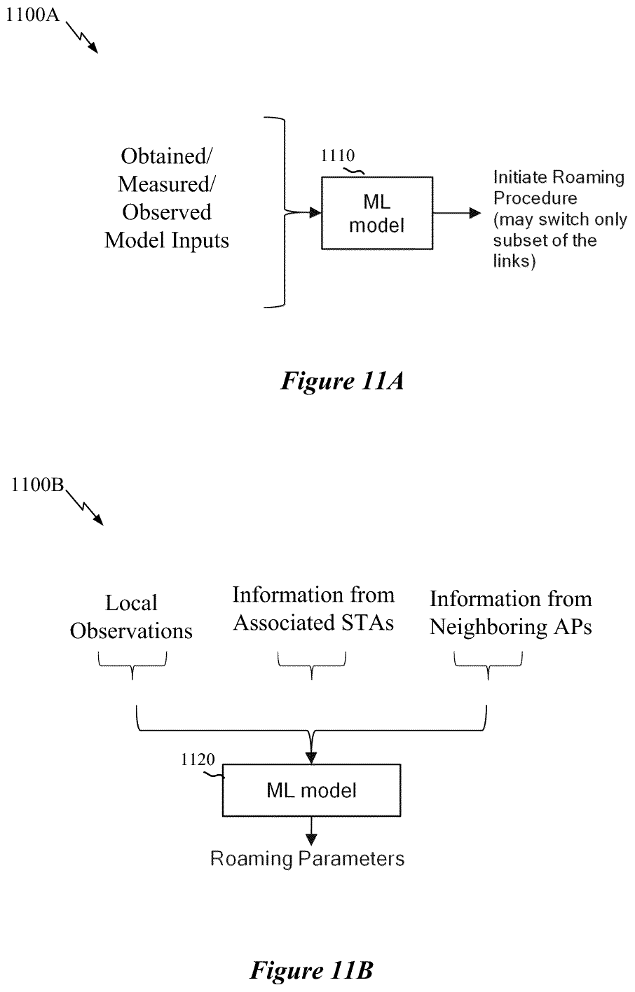

As illustrated in FIG. 11A, inputs to an ML model 1110 to generate roaming decisions (e.g., to initiate a roaming procedure and/or switch on/off certain links) may include one or more of obtained model inputs, measured model inputs, and observed model inputs.

Examples of such inputs include an average signal to interference and noise ratio (SINR), for example, for a last M (e.g., M=10) PPDUs. Inputs could also include an estimated distance to an AP or last N (e.g., N=4)) RSSI measurements from the AP and/or an estimated distance to candidate neighboring APs (could be of same MLD/SMD).

Example model inputs could also include observed per-link packets statistics for K samples (e.g., packet success rate, packet retry rate, packet failure rate), observed load per-link (e.g., airtime utilization, number of devices), or observed interruption per link (e.g., while counting down, a number of collisions).

Example model inputs could also include flow priority, for example, that could be related to Access Category (e.g., voice/AC_VO), a traffic identifier (TID), or a stream classification service (SCS) ID. Example model inputs could also include other parameters, such as link capacity, for example, as indicated by bandwidth (BW), modulation and coding scheme (MCS) and/or a number of spatial streams (NSS).

In some cases, an AP may collect information from associated STAs and/or neighboring APs to determine a roaming model (and/or corresponding model parameters) to announce to clients and/or to disable ML based roaming.

As illustrated in FIG. 11B, inputs to an ML model 1120 to determine an ML model and/or roaming parameters may include one or more of local observations, information from associated stations, or information from neighboring APs.

Local observations may include, for example, (downlink) packet statistics (e.g., success rate, failure rate) and/or per-link loading statistics. Local observations may also include setup SCS agreements, target wakeup time (TWT) service periods (SPs) and a number of random backoff (RBO) interruptions.

Information from associated STAs may include a number of APs observed (by each STA), (uplink) packets statistics (e.g., success rate, failure rate), reported link loads, RBO interruptions, and estimated distances to neighboring APs (or RSSI reports).

Similarly, information from neighboring APs may include (DL) packets statistics (e.g., success rate, failure rate, retry rate), per link load statistics, setup SCS agreements, TWT SPs), and a number of RBO interruptions.

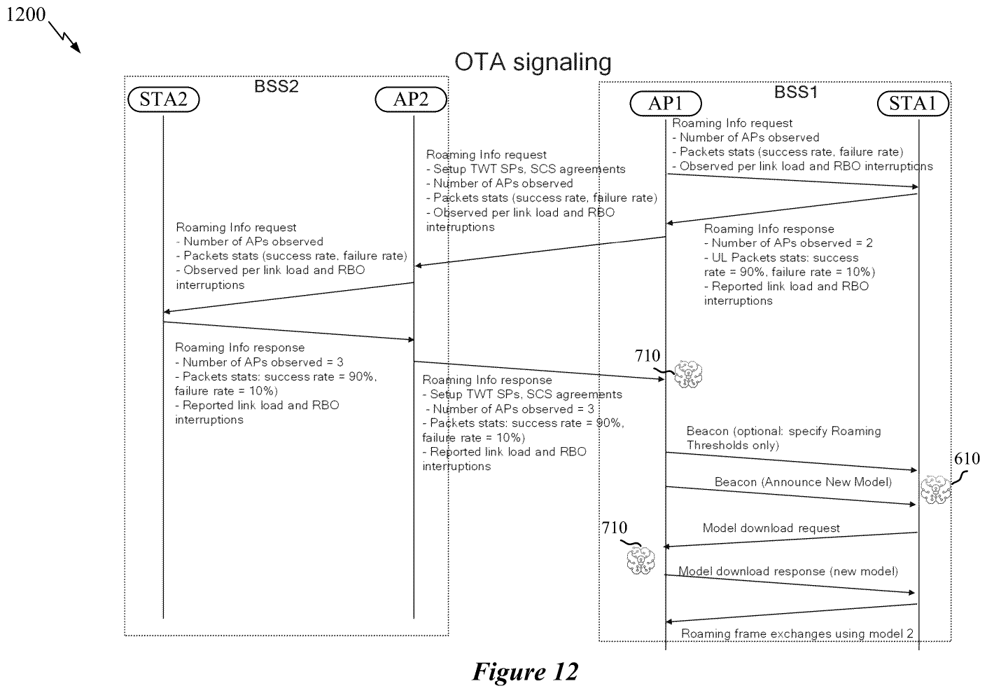

FIG. 12 illustrates an example of how an AP may collect information from associated STAs and/or neighboring APs. The example assumes two BSSs, BSS1 that includes STA1 served by AP1 and BSS2 that includes STA2 served by AP2.

As illustrated, AP1 may send a roaming information request to STA1. The request may indicate what information is requested, such as a number of APs observed (by STA2), packets statistics (success rate, failure rate), and observed per link load and RBO interruptions. STA1 may respond with a roaming information response including requested information. In the illustrated example, STA1 responds with a number of APs observed (2), uplink packet statistics (success rate=90%, failure rate=10%), a reported link load, and RBO interruptions.

As illustrated, AP1 may also send a roaming information request to AP2, which may also indicate the information requested. While some of the requested information may be available at AP2, AP2 may send a roaming information request to STA2 for other information. In the illustrated example, STA1 responds with a number of APs observed (3), uplink packet statistics (success rate=90%, failure rate=10%), a reported link load, and RBO interruptions. As illustrated, AP2 may respond, to AP1, including the requested information (that it obtained locally and obtained from STA2).

As illustrated, AP1 may use the information (and possibly local information) as input to ML model 710. Based on the generated inference, A1 may send an update (e.g., via a beacon) with roaming parameters or a new model. STA1 may use this information as input into ML model 610 and, in some cases, may send a model download request. AP1 may provide the new model in a model download response. STA1 may use the updated model for roaming frame exchanges.

In some cases, an AP may downloads ML models that are scenario specific (e.g., particularly suited for certain use cases). In some cases, an AP may use different models for different STAs, for example, based on QoS requirements and traffic flows (e.g., TID or SCS based).

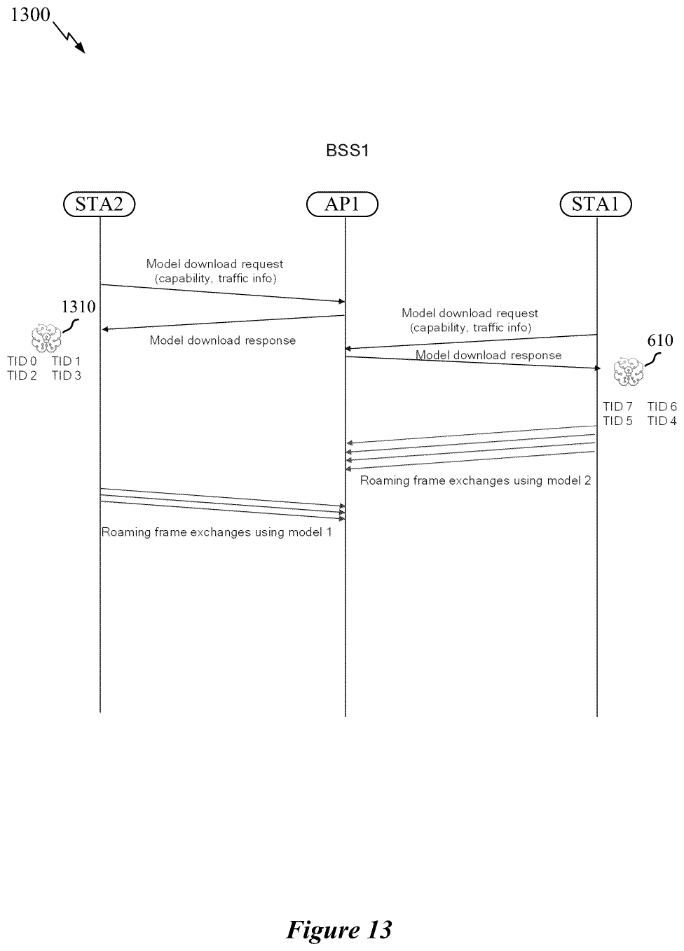

FIG. 13 illustrates an example of an AP (AP1) using different ML models for different STAs (STA1 and STA2).

As illustrated, STA2 may send a model download request, which may indicate capability and traffic information (e.g., for TIDs 0-3). AP1 may respond with a model 1310 selected based on the information. STA2 may then use this model for roaming frame exchanges.

Similarly, STA1 may send a model download request, which may indicate capability and traffic information (e.g., for TIDs 4-7). AP1 may respond with a model 610 selected based on the information. STA1 may then use this model for roaming frame exchanges.

As noted above, there may be a wide variety of ML model inputs, outputs and inferences for ML based roaming.

Roaming model inputs may include be local observation/measurements that are computed/obtained without explicit exchange from another STA. For example, this information may include measured RSSI of candidate links (covers both Wi-Fi links (neighboring AP(s) link(s)) and/or cellular link(s) available), and experienced history per link (e.g., packet success rate, packet retry rate, packet failure rate) that can be aggregated as a score or fed to a model by itself.

Roaming model inputs may also include current experience of the active link (if any) including one or more of packet success rate, packet retry rate, packet failure rate for different TIDs/Access Categories that can be aggregated as a score or fed to a model by itself. These metrics may be aggregated between different access categories, TIDS, SCSIDs or flow IDs based on MPDUs failing/succeeding which can be collected from BA frames.

Roaming model inputs may also include observed load per link including statistics computed by the client, such as airtime utilization, number of devices (e.g., based on the MAC address), observed interruption per link (e.g., while counting down and/or collisions). Roaming model inputs may also include mobility information (e.g., device not moving vs. device is moving which may include location information or estimated distance to other APs/gNBs), a number of observed/scanned (B-) SSIDs (e.g., to determine if this is a home network or not), flow priority that could be related to Access Category (e.g., AC_VO), TID, SCSID or determined based on AI/ML model, and/or link capacity (BW/MCS/NSS).

Roaming model inputs may include observations, measurements, or feedback obtained from another STA (e.g., via over the air OTA signaling). These inputs may include, for example, reported statistics by the AP carried in broadcast frames (E.g., Beacon frame, BTM Query/Request/Response frames), parameters related to candidate APs (Based on R-TWT/SCS, Number of users, Link capacity (BW/MCS/NSS), RSSI levels over a past time window), experienced history per AP/link (device frequently associate with that AP or not), and AI/ML model parameters (e.g., learning rate in RL).

In some cases, the time frame (of applicability/validity) of the model input parameters may vary for same types or different types of inputs. For example, the time frame may be short term (e.g., past few seconds) or long term (e.g., past few hours or days) or a combination thereof, for example, with different weights associated with the different time frames (e.g., weighing more recent measurements/observations more heavily than older ones, or vice-versa). Some of the model parameters may be the output of another local/shared model (e.g., RSSI bad/low/high threshold).

Examples of roaming model outputs may include roaming thresholds (e.g., different thresholds such as good/bad/low/high for RSSI and/or link speed threshold) or actions/decisions such as whether to roam (associate) with another AP/network or not. Roaming outputs may also be estimated performance metric upon use of specific roaming parameter, such as an estimated throughput, latency, or success probability.

In some cases, roaming model rewards may be used, for example, in the case of reinforcement learning. Such rewards may be based on the client key performance indicator (KPI) requirements and/or network level KPI (such as aggregated throughput, average minimum/maximum APs load, average number of clients not satisfied in the network). In some cases, by downloading such model(s) on clients, more clients may be able to achieve their target KPIs.

In certain cases, model inference may be the same as model output. In some cases, however, when the output of a model is an estimated KPI, such as the estimated throughput, the model inference may be derived from the model input. KPIs can be either client KPIs (e.g., network throughput or latency) or network KPIs (e.g., aggregate network throughput).

In some cases, various forms of model management may be implemented. In some cases, such model management may include model tuning, in which an AP may dictate whether STAs can tune (e.g., retrain/refine) an ML model used for ML based roaming.

Model management may also include management of model usage and updates. In some cases, a model may be used for association of new clients or roaming of existing clients. A model may also be used always or triggered once the client KPIs start failing their targets. An AP can provide updated ML models based on certain triggers. Such triggers may include, for example, a new STA entering a BSS, a new AP being detected in a vicinity, traffic profile changes at a STA, or when a STA requests an updated model. In some cases, an AP may use an existing critical update framework for model management (e.g., to notify the STAs of model updates).

### Example Operations

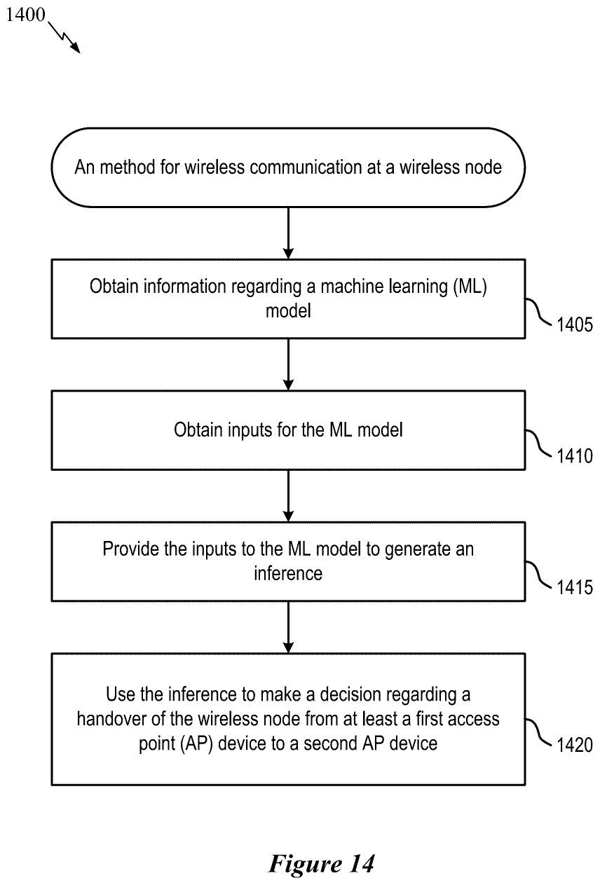

FIG. 14 shows an example of a method 1400 of wireless communication at a wireless node, such as a STA 104 of FIG. 1.

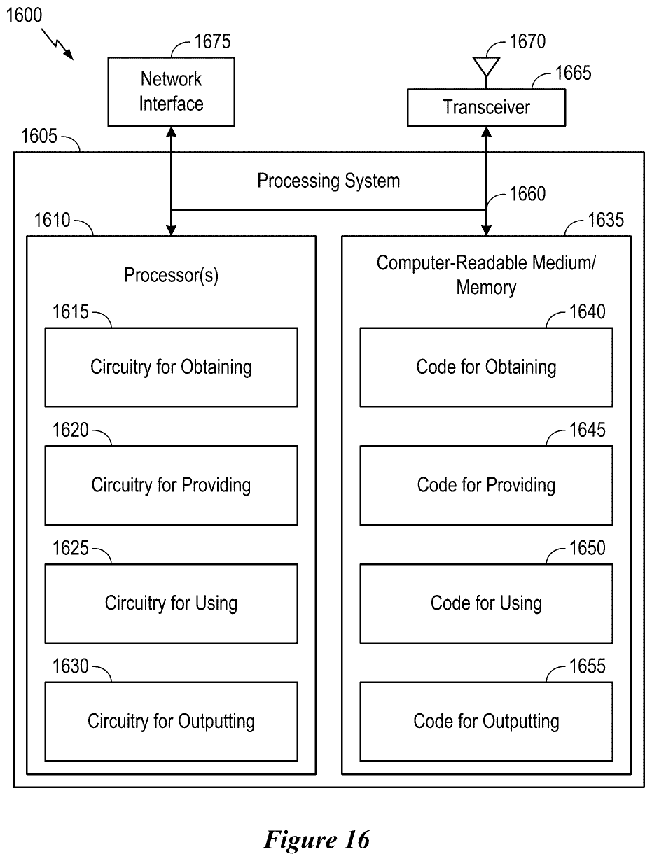

Method 1400 begins at step 1405 with obtaining information regarding a machine learning (ML) model. In some cases, the operations of this step refer to, or may be performed by, circuitry for obtaining and/or code for obtaining as described with reference to FIG. 16.

Method 1400 then proceeds to step 1410 with obtaining inputs for the ML model. In some cases, the operations of this step refer to, or may be performed by, circuitry for obtaining and/or code for obtaining as described with reference to FIG. 16.

Method 1400 then proceeds to step 1415 with providing the inputs to the ML model to generate an inference. In some cases, the operations of this step refer to, or may be performed by, circuitry for providing and/or code for providing as described with reference to FIG. 16.

Method 1400 then proceeds to step 1420 with using the inference to make a decision regarding a handover of the wireless node from at least a first access point (AP) device to a second AP device. In some cases, the operations of this step refer to, or may be performed by, circuitry for using and/or code for using as described with reference to FIG. 16.

In some aspects, the information regarding the ML model is obtained from at least one of: the first AP device or another wireless node.

In some aspects, the information is at least one of: used as input to the ML model; used to configure the ML model; or the ML model.

In some aspects, the first AP device and the second AP device are affiliated with a single mobility domain (SMD) entity.

In some aspects, the method 1400 further includes outputting, for transmission, a request for the ML model, wherein at least some of the information is obtained in response to the request. In some cases, the operations of this step refer to, or may be performed by, circuitry for outputting and/or code for outputting as described with reference to FIG. 16.

In some aspects, the method 1400 further includes obtaining, from at least the first AP device, a request for roaming information. In some cases, the operations of this step refer to, or may be performed by, circuitry for obtaining and/or code for obtaining as described with reference to FIG. 16.

In some aspects, the method 1400 further includes outputting, for transmission, a response including roaming information. In some cases, the operations of this step refer to, or may be performed by, circuitry for outputting and/or code for outputting as described with reference to FIG. 16.

In some aspects, the roaming information comprises at least one of: a number of APs observed by the wireless node, packet statistics, one or more metrics regarding at least one of link loading or random back off interruptions.

In some aspects, the information comprises information regarding different ML models for different traffic flows.

In some aspects, obtaining at least some of the inputs comprises at least one of measuring or observing one or more metrics at the wireless node.

In some aspects, the metrics comprise one or more metrics measured for one or more candidate links.

In some aspects, the one or more metrics are based on at least one of a packet success rate, a packet retry rate, or a packet failure rate.

In some aspects, the metrics include metrics for at least one of: different traffic identifiers (TIDs); different access categories; different stream classification service identifiers; or flow identifiers.

In some aspects, the one or more metrics relate to at least one of loading, interruption, mobility information, a number of observed service set identifiers, flow priority, or link capacity.

In some aspects, obtaining the inputs comprises obtaining at least one of one or more metrics or one or more ML model parameters from at least one of: the first AP device or another wireless node.

In some aspects, the metrics comprise one or more metrics for at least one of: one or more candidate APs or one or more candidate links.

In some aspects, the inference relates to at least one of: a roaming parameter; a roaming decision; or an estimated performance metric associated with a roaming parameter.

In some aspects, the method 1400 further includes obtaining, from the first AP or another wireless node, signaling indicating at least one of whether the wireless node can tune the ML model, when the wireless node can use the ML model, or one or more updates to the ML model or other ML models. In some cases, the operations of this step refer to, or may be performed by, circuitry for obtaining and/or code for obtaining as described with reference to FIG. 16.

In one aspect, method 1400, or any aspect related to it, may be performed by an apparatus, such as communications device 1600 of FIG. 16, which includes various components operable, configured, or adapted to perform the method 1400. Communications device 1600 is described below in further detail.

Note that FIG. 14 is just one example of a method, and other methods including fewer, additional, or alternative steps are possible consistent with this disclosure.

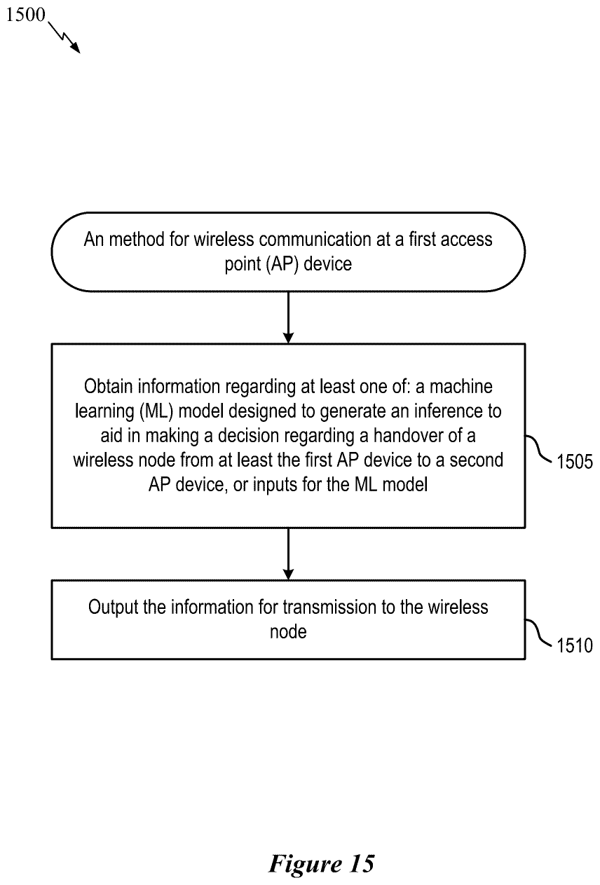

FIG. 15 shows an example of a method 1500 of wireless communication at a first access point (AP) device, such as an AP 102 of FIG. 1.

Method 1500 begins at step 1505 with obtaining information regarding at least one of: a machine learning (ML) model designed to generate an inference to aid in making a decision regarding a handover of a wireless node from at least the first AP device to a second AP device, or inputs for the ML model. In some cases, the operations of this step refer to, or may be performed by, circuitry for obtaining and/or code for obtaining as described with reference to FIG. 16.

Method 1500 then proceeds to step 1510 with outputting the information for transmission to the wireless node. In some cases, the operations of this step refer to, or may be performed by, circuitry for outputting and/or code for outputting as described with reference to FIG. 16.

In some aspects, at least some of the information is obtained from at least one of: the second AP device, the wireless node, or another wireless node.

In some aspects, the first AP device and the second AP device are affiliated with a single mobility domain (SMD) entity.

In some aspects, the method 1500 further includes obtaining, from the wireless node, a request for the ML model, wherein at least some of the information is output for transmission in response to the request. In some cases, the operations of this step refer to, or may be performed by, circuitry for obtaining and/or code for obtaining as described with reference to FIG. 16.

In some aspects, the method 1500 further includes outputting, for transmission to the wireless node, a request for roaming information. In some cases, the operations of this step refer to, or may be performed by, circuitry for outputting and/or code for outputting as described with reference to FIG. 16.

In some aspects, the method 1500 further includes obtaining, from the wireless node, a response including roaming information. In some cases, the operations of this step refer to, or may be performed by, circuitry for obtaining and/or code for obtaining as described with reference to FIG. 16.

In some aspects, the roaming information comprises at least one of: a number of APs observed by the wireless node, packet statistics, one or more metrics regarding at least one of link loading or random back off interruptions.

In some aspects, the information comprises information regarding different ML models for different traffic flows.

In some aspects, the information comprises at least one of one or more metrics or one or more ML model parameters.

In some aspects, the metrics comprise one or more metrics for at least one of: one or more candidate APs or one or more candidate links.

In some aspects, the inference relates to at least one of: a roaming parameter; a roaming decision; or an estimated performance metric associated with a roaming parameter.

In some aspects, the method 1500 further includes outputting, for transmission to the wireless node, signaling indicating at least one of whether the wireless node can tune the ML model, when the wireless node can use the ML model, or one or more updates to the ML model or other ML models. In some cases, the operations of this step refer to, or may be performed by, circuitry for outputting and/or code for outputting as described with reference to FIG. 16.

In one aspect, method 1500, or any aspect related to it, may be performed by an apparatus, such as communications device 1600 of FIG. 16, which includes various components operable, configured, or adapted to perform the method 1500.

Communications device 1600 is described below in further detail.

Note that FIG. 15 is just one example of a method, and other methods including fewer, additional, or alternative steps are possible consistent with this disclosure.

### Example Communications Device(s)

FIG. 16 depicts aspects of an example communications device 1600. In some aspects, communications device 1600 is a station, such as a STA 104 described above with respect to FIGS. 1 and 2. In some aspects, communications device 1600 is an access point, such as an AP 102 described above with respect to FIG. 1.

The communications device 1600 includes a processing system 1605 coupled to the transceiver 1665 (e.g., a transmitter and/or a receiver). The transceiver 1665 is configured to transmit and receive signals for the communications device 1600 via the antenna 1670, such as the various signals as described herein. The processing system 1605 may be configured to perform processing functions for the communications device 1600, including processing signals received and/or to be transmitted by the communications device 1600.

The processing system 1605 includes one or more processors 1610. The one or more processors 1610 are coupled to a computer-readable medium/memory 1635 via a bus 1660. In certain aspects, the computer-readable medium/memory 1635 is configured to store instructions (e.g., computer-executable code) that when executed by the one or more processors 1610, cause the one or more processors 1610 to perform the method 1400 described with respect to FIG. 14, or any aspect related to it; and the method 1500 described with respect to FIG. 15, or any aspect related to it. Note that reference to a processor performing a function of communications device 1600 may include one or more processors 1610 performing that function of communications device 1600.

In the depicted example, computer-readable medium/memory 1635 stores code (e.g., executable instructions), such as code for obtaining 1640, code for providing 1645, code for using 1650, and code for outputting 1655. Processing of the code for obtaining 1640, code for providing 1645, code for using 1650, and code for outputting 1655 may cause the communications device 1600 to perform the method 1400 described with respect to FIG. 14, or any aspect related to it; and the method 1500 described with respect to FIG. 15, or any aspect related to it.

The one or more processors 1610 include circuitry configured to implement (e.g., execute) the code stored in the computer-readable medium/memory 1635, including circuitry for obtaining 1615, circuitry for providing 1620, circuitry for using 1625, and circuitry for outputting 1630. Processing with circuitry for obtaining 1615, circuitry for providing 1620, circuitry for using 1625, and circuitry for outputting 1630 may cause the communications device 1600 to perform the method 1400 described with respect to FIG. 14, or any aspect related to it; and the method 1500 described with respect to FIG. 15, or any aspect related to it.

Various components of the communications device 1600 may provide means for performing the method 1400 described with respect to FIG. 14, or any aspect related to it; and the method 1500 described with respect to FIG. 15, or any aspect related to it. For example, means for transmitting, sending or outputting for transmission may include the transceiver 1665 and the antenna 1670 of the communications device 1600 in FIG. 16. Means for receiving or obtaining may include the transceiver 1665 and the antenna 1670 of the communications device 1600 in FIG. 16. Means for communicating may include the transceiver 1665 and the antenna 1670 of the communications device 1600 in FIG. 16. Means for obtaining, means for providing, means for using, and means for outputting may comprise one or more processors, such as one or more of the processors described above with reference to FIG. 16.

### Example Clauses

Implementation examples are described in the following numbered clauses:

Clause 1: An method for wireless communication at a wireless node, comprising: obtaining information regarding a machine learning (ML) model; obtaining inputs for the ML model; providing the inputs to the ML model to generate an inference; and using the inference to make a decision regarding a handover of the wireless node from at least a first access point (AP) device to a second AP device.

Clause 2: The method of Clause 1, wherein the information regarding the ML model is obtained from at least one of: the first AP device or another wireless node.

Clause 3: The method of any one of Clauses 1-2, wherein the information is at least one of: used as input to the ML model; used to configure the ML model; or the ML model.

Clause 4: The method of any one of Clauses 1-3, wherein the first AP device and the second AP device are affiliated with a single mobility domain (SMD) entity.

Clause 5: The method of any one of Clauses 1-4, further comprising: outputting, for transmission, a request for the ML model, wherein at least some of the information is obtained in response to the request.

Clause 6: The method of any one of Clauses 1-5, further comprising: obtaining, from at least the first AP device, a request for roaming information; and outputting, for transmission, a response including roaming information.

Clause 7: The method of any one of Clauses 1-6, wherein the roaming information comprises at least one of: a number of APs observed by the wireless node, packet statistics, one or more metrics regarding at least one of link loading or random back off interruptions.

Clause 8: The method of any one of Clauses 1-7, wherein the information comprises information regarding different ML models for different traffic flows.

Clause 9: The method of any one of Clauses 1-8, wherein obtaining at least some of the inputs comprises at least one of measuring or observing one or more metrics at the wireless node.

Clause 10: The method of Clause 9, wherein the metrics comprise one or more metrics measured for one or more candidate links.

Clause 11: The method of Clause 9, wherein the one or more metrics are based on at least one of a packet success rate, a packet retry rate, or a packet failure rate.

Clause 12: The method of Clause 9, wherein the metrics include metrics for at least one of: different traffic identifiers (TIDs); different access categories; different stream classification service identifiers; or flow identifiers.

Clause 13: The method of Clause 9, wherein the one or more metrics relate to at least one of loading, interruption, mobility information, a number of observed service set identifiers, flow priority, or link capacity.

Clause 14: The method of any one of Clauses 1-13, wherein obtaining the inputs comprises obtaining at least one of one or more metrics or one or more ML model parameters from at least one of: the first AP device or another wireless node.

Clause 15: The method of Clause 14, wherein the metrics comprise one or more metrics for at least one of: one or more candidate APs or one or more candidate links.

Clause 16: The method of any one of Clauses 1-15, wherein the inference relates to at least one of: a roaming parameter; a roaming decision; or an estimated performance metric associated with a roaming parameter.

Clause 17: The method of any one of Clauses 1-16, further comprising: obtaining, from the first AP or another wireless node, signaling indicating at least one of whether the wireless node can tune the ML model, when the wireless node can use the ML model, or one or more updates to the ML model or other ML models.

Clause 18: An method for wireless communication at a first access point (AP) device, comprising: obtaining information regarding at least one of: a machine learning (ML) model designed to generate an inference to aid in making a decision regarding a handover of a wireless node from at least the first AP device to a second AP device, or inputs for the ML model; and outputting the information for transmission to the wireless node.

Clause 19: The method of Clause 18, wherein at least some of the information is obtained from at least one of: the second AP device, the wireless node, or another wireless node.

Clause 20: The method of any one of Clauses 18-19, wherein the first AP device and the second AP device are affiliated with a single mobility domain (SMD) entity.

Clause 21: The method of any one of Clauses 18-20, further comprising: obtaining, from the wireless node, a request for the ML model, wherein at least some of the information is output for transmission in response to the request.

Clause 22: The method of any one of Clauses 18-21, further comprising: outputting, for transmission to the wireless node, a request for roaming information; and obtaining, from the wireless node, a response including roaming information.

Clause 23: The method of Clause 22, wherein the roaming information comprises at least one of: a number of APs observed by the wireless node, packet statistics, one or more metrics regarding at least one of link loading or random back off interruptions.

Clause 24: The method of any one of Clauses 18-23, wherein the information comprises information regarding different ML models for different traffic flows.

Clause 25: The method of any one of Clauses 18-24, wherein the information comprises at least one of one or more metrics or one or more ML model parameters.

Clause 26: The method of Clause 25, wherein the metrics comprise one or more metrics for at least one of: one or more candidate APs or one or more candidate links.

Clause 27: The method of any one of Clauses 18-26, wherein the inference relates to at least one of: a roaming parameter; a roaming decision; or an estimated performance metric associated with a roaming parameter.

Clause 28: The method of any one of Clauses 18-27, further comprising: outputting, for transmission to the wireless node, signaling indicating at least one of whether the wireless node can tune the ML model, when the wireless node can use the ML model, or one or more updates to the ML model or other ML models.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

Clause 33: A wireless node, comprising: at least one transceiver; a memory comprising executable instructions; and one or more processors configured to execute the executable instructions and cause the wireless node to perform a method in accordance with any one of Clauses 1-17, wherein the at least one transceiver is configured to receive the information.

Clause 34: A wireless node, comprising: at least one transceiver; a memory comprising executable instructions; and one or more processors configured to execute the executable instructions and cause the wireless node to perform a method in accordance with any one of Clauses 18-28, wherein the at least one transceiver is configured to receive the information.

### ADDITIONAL CONSIDERATIONS

As used herein, the term “determine” or “determining” encompasses a wide variety of actions and, therefore, “determining” can include calculating, computing, processing, deriving, investigating, looking up (such as via looking up in a table, a database or another data structure), inferring, ascertaining, measuring, and the like. Also, “determining” can include receiving (such as receiving information), accessing (such as accessing data stored in memory), transmitting (such as transmitting information) and the like. Also, “determining” can include resolving, selecting, obtaining, choosing, establishing and other such similar actions.

As used herein, a phrase referring to “at least one of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b.

As used herein, “based on” is intended to be interpreted in the inclusive sense, unless otherwise explicitly indicated. For example, “based on” may be used interchangeably with “based at least in part on,” “associated with”, or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions or information.

As used herein, “a processor.” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

The various illustrative components, logic, logical blocks, modules, circuits, operations and algorithm processes described in connection with the examples disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. An apparatus for wireless communication, comprising: a memory comprising computer-executable instructions; and one or more processors configured to execute the computer-executable instructions and cause the apparatus to:
obtain information regarding a machine learning (ML) model;
obtain inputs for the ML model;
provide the inputs to the ML model to generate an inference; and
use the inference to make a decision regarding a handover of the apparatus from at least a first access point (AP) device to a second AP device.

2. The apparatus of claim 1, wherein the information regarding the ML model is obtained from at least one of: the first AP device or a wireless node.

3. The apparatus of claim 1, wherein the information is at least one of:
used as input to the ML model;
used to configure the ML model; or
the ML model.

4. The apparatus of claim 1, wherein the first AP device and the second AP device are affiliated with a single mobility domain (SMD) entity.

5. The apparatus of claim 1, wherein the one or more processors are further configured to execute the computer-executable instructions and cause the apparatus to:
output, for transmission, a request for the ML model, wherein at least some of the information is obtained in response to the request.

6. The apparatus of claim 1, wherein the one or more processors are further configured to execute the computer-executable instructions and cause the apparatus to:
obtain, from at least the first AP device, a request for roaming information; and
output, for transmission, a response including roaming information.

7. The apparatus of claim 6, wherein the roaming information comprises at least one of: a number of APs observed by the apparatus, packet statistics, one or more metrics regarding at least one of link loading or random back off interruptions.

8. The apparatus of claim 1, wherein the information comprises information regarding different ML models for different traffic flows.

9. The apparatus of claim 1, wherein obtaining at least some of the inputs comprises at least one of measuring or observing one or more metrics at the apparatus.

10. The apparatus of claim 9, wherein the metrics comprise one or more metrics measured for one or more candidate links.

11. The apparatus of claim 9, wherein the one or more metrics are based on at least one of a packet success rate, a packet retry rate, or a packet failure rate.

12. The apparatus of claim 9, wherein the metrics include metrics for at least one of:
different traffic identifiers (TIDs);
different access categories;
different stream classification service identifiers; or
flow identifiers.

13. The apparatus of claim 9, wherein the one or more metrics relate to at least one of loading, interruption, mobility information, a number of observed service set identifiers, flow priority, or link capacity.

14. The apparatus of claim 1, wherein obtaining the inputs comprises obtaining at least one of one or more metrics or one or more ML model parameters from at least one of: the first AP device or a wireless node.

15. The apparatus of claim 14, wherein the metrics comprise one or more metrics for at least one of: one or more candidate APs or one or more candidate links.

16. The apparatus of claim 1, wherein the inference relates to at least one of:
a roaming parameter;
a roaming decision; or
an estimated performance metric associated with a roaming parameter.

17. The apparatus of claim 1, wherein the one or more processors are further configured to execute the computer-executable instructions and cause the apparatus to obtain, from the first AP or a wireless node, signaling indicating at least one of:
whether the apparatus can tune the ML model;
when the apparatus can use the ML model; or
one or more updates to the ML model or other ML models.

18. The apparatus of claim 1, further comprising:
at least one transceiver configured to receive the information, wherein the apparatus is configured as a wireless station (STA).

19. An apparatus for wireless communication, comprising: a memory comprising computer-executable instructions; and one or more processors configured to execute the computer-executable instructions and cause the apparatus to:
obtain information regarding at least one of:
a machine learning (ML) model designed to generate an inference to aid in making a decision regarding a handover of a wireless node from at least a first access point (AP) device to a second AP device, or
inputs for the ML model; and
output the information for transmission to the wireless node.

20. The apparatus of claim 19, wherein at least some of the information is obtained from at least one of: the second AP device, the wireless node, or another wireless node.

21. The apparatus of claim 19, wherein the first AP device and the second AP device are affiliated with a single mobility domain (SMD) entity.

22. The apparatus of claim 19, wherein the one or more processors are further configured to execute the computer-executable instructions and cause the apparatus to:
obtain, from the wireless node, a request for the ML model, wherein at least some of the information is output for transmission in response to the request.

23. The apparatus of claim 19, wherein the one or more processors are further configured to execute the computer-executable instructions and cause the apparatus to:
output, for transmission to the wireless node, a request for roaming information; and
obtain, from the wireless node, a response including roaming information.

24. The apparatus of claim 23, wherein the roaming information comprises at least one of: a number of APs observed by the wireless node, packet statistics, one or more metrics regarding at least one of link loading or random back off interruptions.

25. The apparatus of claim 19, wherein the information comprises at least one of:
information regarding different ML models for different traffic flows,
one or more metrics, or
one or more ML model parameters.

26. The apparatus of claim 25, wherein the metrics comprise one or more metrics for at least one of: one or more candidate APs or one or more candidate links.

27. The apparatus of claim 19, wherein the inference relates to at least one of:
a roaming parameter;
a roaming decision; or
an estimated performance metric associated with a roaming parameter.

28. The apparatus of claim 19, wherein the one or more processors are further configured to execute the computer-executable instructions and cause the apparatus to output, for transmission to the wireless node, signaling indicating at least one of:
whether the wireless node can tune the ML model;
when the wireless node can use the ML model; or
one or more updates to the ML model or other ML models.

29. The apparatus of claim 19, further comprising:
at least one transceiver configured to receive the information, wherein the apparatus is configured as the first AP device.

30. A method for wireless communication at a wireless node, comprising:
obtaining information regarding a machine learning (ML) model;
obtaining inputs for the ML model;
providing the inputs to the ML model to generate an inference; and
using the inference to make a decision regarding a handover of the wireless node from at least a first access point (AP) device to a second AP device.
